(19) United States
(12) Patent Application Publication
(10) Pub. No.: US 2023/0314347 A1
(43) Pub. Date: Oct. 5, 2023

(54) Configurable Detector Panel for an X-Ray Imaging System

(71) Applicant: Viken Detection Corporation, Burlington, MA (US)

(72) Inventors: James P. Ryan, Bedford, NH (US); Lane Marsden, Reading, MA (US); Peter J. Rothschild, Newton, MA (US)

(21) Appl. No.: 18/194,002

(22) Filed: Mar. 31, 2023

Related U.S. Application Data
(60) Provisional application No. 63/362,306, filed on Mar. 31, 2022.
(60) Provisional application No. 63/364,190, filed on May 4, 2022.

(51) Int. Cl. G01N 23/20008; G01N 23/203; G01N 23/04; G01N 23/083

(52) U.S. Cl. CPC G01N 23/20008; G01N 23/203; G01N 23/04; G01N 23/083; G01N 2223/505; G01N 2223/33

(57) ABSTRACT

A handheld or portable x-ray imaging system includes a housing containing an x-ray source for generating a sweeping beam, and an external detector panel mounted onto a positioning arm to allow an operator to position the external detector panel relative to the housing. The detector panel may have a width of between 1 inch and 18 inches. Embodiments allow for portable x-ray scanning in locations that can otherwise be difficult or impossible to reach with existing handheld detectors.

### RELATED APPLICATIONS

This application claims the benefit of U.S. Provisional Application No. 63/364,190, filed on May 4, 2022 and U.S. Provisional Application No. 63/362,306, filed on Mar. 31, 2022. The entire teachings of the above application(s) are incorporated herein by reference.

### BACKGROUND

X-ray backscatter imaging has been used for detecting concealed contraband, such as drugs, explosives, and weapons, since the late 1980's. Unlike traditional transmission x-ray imaging that creates images by detecting the x-rays penetrating through an object, backscatter imaging uses reflected or scattered x-rays to create the image. The basic principle is shown in FIG. 1. A standard x-ray tube 14 generates the x-rays that are collimated into a fan beam 16 by a slit in attenuating plate 19. The fan beam is then “chopped” into a pencil beam by a rotating “chopper wheel” 18 with slits 21, which scans over the object being imaged as the wheel rotates. The intensity of the x-rays scattered in the backwards direction is then recorded by one or more large-area backscatter detectors (not shown) as a function of the position of the illuminating beam. By moving the object through the plane containing the scanning beam, either on a conveyor 27 or under its own power, a two-dimensional backscatter image of the object is obtained. Alternatively, the object can be stationary, and the imaging system can be moved relative to the object.

In the last few years, handheld x-ray backscatter imaging devices have been introduced into the market, enabling an operator to inspect suspect vehicles, packages, or other objects conveniently. These devices have been designed to be relatively compact and lightweight, allowing them to be easily operated for extended periods of time.

### SUMMARY

In an embodiment, an x-ray imaging system includes a movable x-ray scanning module configured to generate a sweeping beam of x-rays, a positioning arm, and a detector panel. The detector panel is coupled to or configured to be coupled to the positioning arm. The positioning arm is configured to allow an operator to position the detector panel relative to the movable x-ray scanning module and with an orientation for receiving x-rays from a target resulting from the sweeping beam of x-rays being incident at the target or transmitted through the target.

In some embodiments, the detector panel is an auxiliary detector panel. The movable x-ray scanning module includes a primary detector oriented to receive backscatter x-rays from the target resulting from the sweeping beam of x-rays being incident at the target. In some embodiments, the primary detector is a panel.

In some embodiments, the primary detector is operably coupled to a primary detector module that is configured to output a primary x-ray image signal. The primary x-ray image signal enables a processor to form a primary x-ray image. The auxiliary detector panel is operably coupled to an auxiliary detector module that is configured to output an auxiliary x-ray image signal responsive to the auxiliary detector panel's receiving x-rays from a target resulting from the sweeping beam of x-rays being incident at the target or transmitted through the target.

In some embodiments, the x-ray imaging system further includes a processor operably coupled to at least one of the primary detector module and the auxiliary detector module. The processor is configured to form an x-ray image as a function of the primary x-ray image signal, auxiliary x-ray image signal, or combination thereof.

In some embodiments, the positioning arm has a mechanical relationship with the moveable x-ray scanning module selected from a group including: coupled to the movable x-ray scanning module; detachable from the x-ray scanning module; or independent from the x-ray scanning module.

In some embodiments, the detector panel is either (i) non-planar and (ii) flexible.

In some embodiments, x-ray imaging system further includes either a location or orientation sensor located in the positioning arm, detector panel, or movable x-ray scanning module. The either location or orientation sensor is configured to output a signal that can be used by a processor to determine a relative location or orientation of the detector panel with respect to the movable x-ray scanning module.

In some embodiments, the positioning arm further includes multiple telescoping sections. The multiple telescoping sections are sufficiently stiff in a fully extended state to support the detector panel in an operator-defined position and orientation.

In some embodiments, the positioning arm is adjustable along its length.

In some embodiments, the detector panel in a coupled arrangement with the positioning arm is configured to be positioned by the operator to receive either (i) transmission x-rays through the target, or (ii) backscatter, side scatter, or forward scatter x-rays from the target.

In some embodiments, the x-ray imaging system further includes (i) one or more electrical cable configured to connect the detector panel operably to a processor of the x-ray imaging system or (ii) a wireless link subsystem configured to connect the detector panel operably to the processor of the x-ray imaging system via a wireless communications protocol.

In an embodiment, the detector panel comprises one or more scintillator volumes configured to be oriented along a scan axis of a scanning beam of x-rays to receive x-rays from the scanning beam transmitted through a target. The one or more scintillator volumes configured to produce scintillation photons responsive to receiving the x-rays. The detector panel further includes multiple ribbons of wavelength-shifting fibers (WSFs) optically coupled to the one or more scintillator volumes along the scan axis via a spatial periodic adjacency of the multiple ribbons to the scan axis. The multiple ribbons configured to receive scintillation photons from the one or more scintillator volumes via the spatial periodic adjacency as the scanning beam of x-rays scans over the scan axis. The detector panel further includes a respective photodetector coupled to an end of each respective ribbon of the plurality of ribbons. Each respective photodetector is configured to detect the scintillation photons carried by the respective ribbon and to produce a respective signal responsively. The detector panel further includes a signal combiner configured to combine, selectively, respective signals from ribbons of the multiple ribbons, for positions of the scanning beam along the scan axis, to create a combined signal representing a scan of the target with enhanced spatial resolution.

In some embodiment, the detector module includes a light detection structure. The light detection structure includes a tubular support structure having a curved outer surface, and multiple ribbons of wavelength-shifting fibers (WSFs) wrapped around the curved outer surface in a spatially periodic, substantially helical pattern. The multiple ribbons of WSFs being configured to carry light to be detected at respective ends of respective ribbons of the multiple ribbons.

In some embodiments, detector module comprises a scintillator volume having an entrance surface and an exit surface. The entrance surface is configured to receive incident x-rays. The scintillator volume is configured to emit scintillation light responsive to the incident x-rays. The exit surface is configured to pass a portion of the incident x-rays that traverse a thickness of the scintillator volume between the entrance surface and the exit surface.

The detector panel further includes a first set of light guides optically coupled to the entrance surface of the scintillator volume and a second set of light guides optically coupled to the exit surface of the scintillator volume. The detector panel further includes a first photodetector optically coupled to an end of the first set of light guides and configured to output a first signal responsive to scintillation light from the scintillator volume. The detector panel further includes a second photodetector optically coupled to an end of the second plurality of light guides and configured to output a second signal responsive to scintillation light from the scintillator volume. The detector panel further includes a spectrum analyzer configured to receive the first and second signals responsive to the scintillation light from the scintillator volume and to determine a characteristic of an energy spectrum of the incident x-rays based on the first and second signals.

In some embodiments, the x-ray imaging system, further includes a detector structure configured for use with the scanning beam of x-rays, the detector panel, and a detector module that is configured to output an x-ray image signal responsive to the detector panel's receiving x-rays from a target resulting from the sweeping beam of x-rays being incident at the target. The detector structure includes multiple ribbons of wavelength-shifting fibers (WSF) optically coupled to one or more layers of scintillator volumes. The scintillator volumes are arranged to optically couple to the WSF ribbons in a repeating pattern along one or more axes of the detector. The detector structure further includes a photodetector coupled to one or more ends of each of the ribbons for detecting scintillation photons. The detector structure further includes a combiner configured to combine the signals from one or more of the ribbons for each orientation of the scanning beam to create a combined signal for each beam orientation, and a processor configured to create an image from the combined signal.

In some embodiments, the x-ray imaging system further includes a light detection structure including a plurality of scintillator volumes configured to be oriented spaced from each other and in a spatially periodic form along a scan axis of a scanning beam of x-rays to receive x-rays from the scanning beam transmitted through a target. The plurality of scintillator volumes are further configured to produce scintillation photons responsive to receiving the x-rays. The system further includes a wavelength-shifting fiber (WSF) ribbon optically coupled to the plurality of scintillator volumes along the scan axis. The ribbons are configured to receive scintillation photons from the plurality of scintillator volumes via the optical coupling as the scanning beam of x-rays scans over the scan axis.

In an embodiment, a detector panel includes a housing made of a flexible material. The housing defines a light-capturing cavity and preventing ambient light from entering the light-capturing cavity. The panel further includes at least one scintillation screen residing within the light-capturing cavity of the housing, the combination of the housing and the at least one scintillation screen being flexible.

In an embodiment, the housing includes or defines a coupling member that enables the detector panel to be coupled to a positioning arm or to a complementary coupling member of the positioning arm or other structure.

In an embodiment, the positioning arm is telescoping, flexible, or foldable.

In an embodiment, the housing has a port for outputting a signal, and the detector panel further includes a detector module configured to output an x-ray image signal responsive to receiving x-rays at the at least one scintillation screen from a target resulting from the sweeping beam of x-rays being incident at a target, such that an x-ray image of the target can be formed using the x-ray image signal.

In an embodiment, the detector panel further includes at least one location or orientation sensor located in the housing configured to determine a location or orientation of the detector panel relative to a source of a sweeping beam of x-rays.

### BRIEF DESCRIPTION OF THE DRAWINGS

FIG. 1 is a schematic illustration of a prior art x-ray backscatter imaging system.

FIG. 2 is a diagram illustrating an example of a handheld backscatter x-ray imaging instrument that operates at 140 kV, with compact built-in backscatter detectors.

FIG. 3 is an illustration of a large-area detector accessory for the handheld system shown in FIG. 2.

FIG. 4 is an illustration of the system shown in FIG. 2 with a large-area detector accessory attached.

FIG. 5 is an illustration of an application of the system shown in FIG. 2 with a sweeping pencil beam and a non-pixelated detector to acquire transmission images of a travel bag.

FIG. 6 is an illustration of use of a cone beam x-ray source combined with a pixelated detector panel to create a very high-resolution transmission image of a suspect item.

FIG. 7 is a diagram illustrating an example transmission image created with the system shown in FIG. 5.

FIG. 8 is a diagram illustrating an example transmission image created with the system shown in FIG. 6.

FIG. 9 is a diagram illustrating an example embodiment of a handheld x-ray backscatter imager with an attached transmission detector bar accessory.

FIG. 10 is a diagram illustrating an example embodiment of the detector panel with a telescoping positioning arm.

FIG. 11 is a diagram illustrating an embodiment of a flexible detector panel with a telescoping positioning arm.

FIG. 12 is a diagram illustrating an example embodiment of the detector panel with one sheet of scintillating phosphor read out with one layer of WSF.

FIG. 13 is a diagram illustrating an example embodiment of a dual-energy version of the detector panel using only one sheet of scintillating phosphor and entrance and exit layers of WSF read out separately.

FIG. 14 is a schematic diagram illustrating an embodiment detector panel system having a foldable positioning arm with various hinged sections.

FIG. 15 is a schematic diagram illustrating an embodiment detector panel system having a bendable positioning arm optional wired or wireless detector signal communications with the handheld imager of FIG. 2.

FIG. 16 is a schematic block diagram illustrating an embodiment x-ray imaging system.

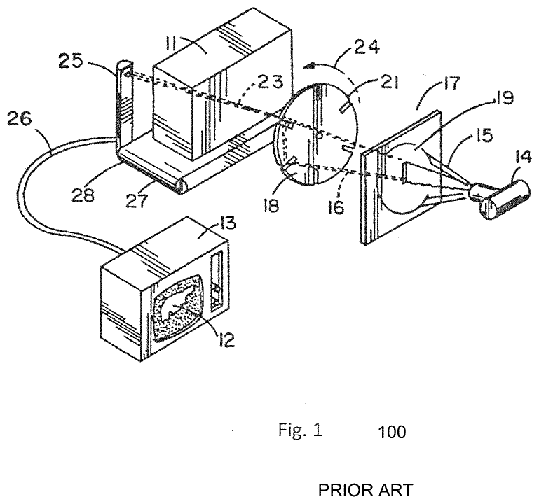

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

### DETAILED DESCRIPTION

A description of example embodiments follows.

Acquiring x-ray images of targets is aided by backscatter detectors, however, many targets do not allow for easy accessibility of such a backscatter detector. In view of this limitation, disclosed herein is an x-ray imaging system having a maneuverable detector panel able to be positioned around targets that traditional x-ray imaging systems would not allow. In an embodiment, the x-ray imaging system includes a movable x-ray scanning module configured to generate a sweeping beam of x-rays, a positioning arm, and a detector panel coupled to or configured to be coupled to the positioning arm. The positioning arm is configured to allow an operator to position the detector panel relative to the movable x-ray scanning module and with an orientation for receiving x-rays from a target resulting from the sweeping beam of x-rays being incident at the target or transmitted through the target.

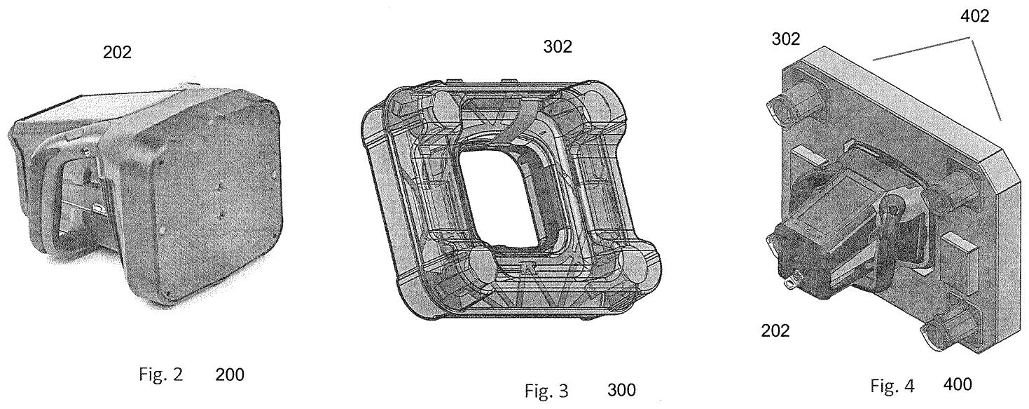

Performance enhancement of handheld backscatter x-ray imaging systems has been achieved by optionally increasing the area of the backscatter detectors. An example of a 120 kV backscatter x-ray imaging system is shown in FIG. 2. FIG. 2 is a diagram 200 illustrating an example of a backscatter detector on a handheld backscatter x-ray imaging system. To allow access to compact spaces and to decrease weight, FIG. 2 illustrates that the built-in backscatter detector 202 on a handheld backscatter x-ray imaging system is typically quite small, such as 2″×6″ in size.

FIG. 3 is a diagram 300 illustrating an example embodiment of a much larger removable detector 302, called the “Large Area Detector” or “LAD.” The LAD offers additional performance for these systems.

FIG. 4 illustrates an ability to rapidly attach the LAD detector (e.g., LAD 302 of FIG. 3) to the front of the imager (e.g., backscatter detector 202 of FIG. 2), allowing the system to image objects from much larger distances, up to several feet. Alternatively, much higher quality images can be obtained at closer distances.

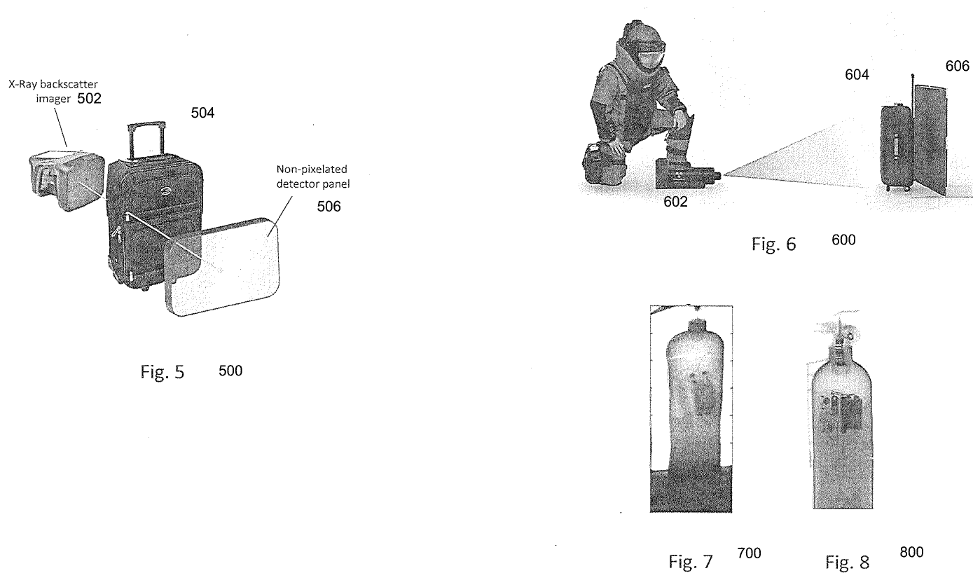

FIG. 5 is a diagram 500 illustrating an example embodiment of obtaining x-ray imaging of an object with a portable system. In addition to backscatter imaging, these handheld x-ray imaging systems 502 can obtain transmission images of an object 504 by placing a stationary non-pixelated (i.e., single-channel) large-area x-ray detector panel 506 behind the object 504 being imaged. The stationary detector panel 506 intercepts the sweeping beam after it has passed through the object, allowing a transmission image to be created simultaneously with the acquisition of the backscatter image.

FIG. 6 is a diagram 600 illustrating an example embodiment of a limitation of the approach of using a sweeping beam to obtain a transmission image. The resolution of the transmission image can be relatively low, as the imaging resolution in this case is defined by the size of the sweeping pencil beam as it passes through the object being imaged. For example, the pencil beam can be ˜5 mm in width at about 30 cm from the front of a small handheld backscatter imaging instrument 602, creating transmission images which can be perceived as being out of focus, or blurry. This is especially the case when the transmission images are compared with an image of an object 604 acquired with a very-high resolution, highly pixelated flat-panel detector 606 illuminated by a cone beam of x-rays, as typically used in the field by bomb disposal technicians. For example, FIG. 7 is an image 700 illustrating an explosive device concealed inside a fire extinguisher, acquired with a pencil beam from a handheld backscatter imager combined with a non-pixelated detector panel. In contrast, FIG. 8 is a comparable image 800 illustrating the same object acquired by a cone beam of x-rays and a pixelated flat panel detector. The image 800 of FIG. 8 has a superior the resolution to the image 700 of FIG. 7.

However, in connection with embodiments described herein that employ a transmission detector with a sweeping x-ray beam, the transmission image obtained with a sweeping beam can be improved by using, for example, the approaches described in PCT Pat. App. Pub. No. WO 2022/040609, entitled “X-Ray Detection Structure and System”; and in PCT Pat. App. No. PCT/US/2022/081897, entitled “X-Ray Detection Structure with Periodic Scintillator Volumes”; both of which are hereby incorporated herein by reference in their entireties.

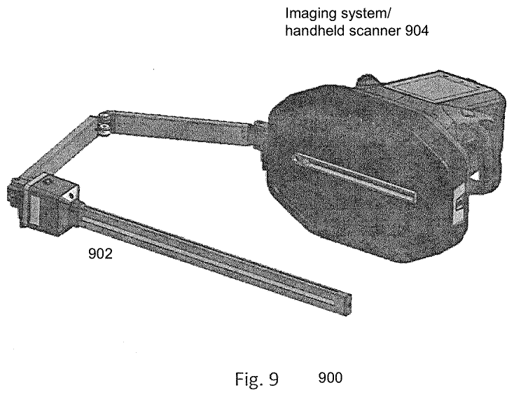

FIG. 9 is a diagram 900 illustrating an example embodiment of a transmission detector bar 902. Rather than using a stationary large-area detector panel with a handheld backscatter x-ray imager to acquire transmission images, a transmission detector bar” 902 or other open geometry transmission that is attached to the imaging system and intercepts the beam after it has been transmitted through the object can be optionally used. However, while a bar or other transmission detector attached to a handheld scanner 904 is convenient for some objects, a transmission detector that moves with the imaging system 904 cannot be used for all objects, such as examining targets that include transmission shafts or truck wheels such targets because often have limited or no space through which to move the detector.

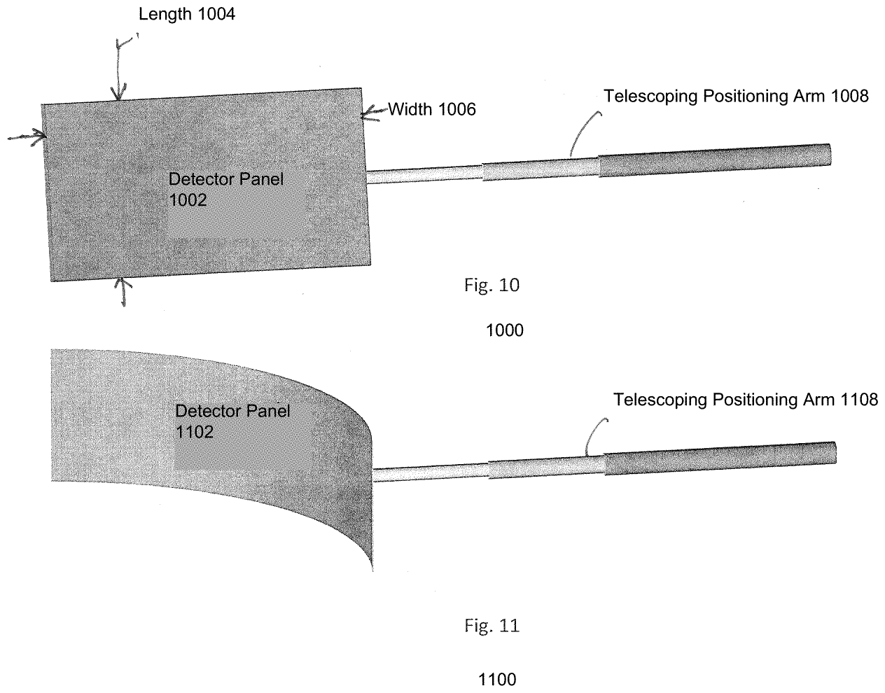

FIG. 10 is a diagram 1000 illustrating example embodiments of compact configurable detector panels 1002 that can be employed in conjunction with a handheld or portable backscatter x-ray imaging system that uses a sweeping beam of x-rays to acquire images. The compact detector panels 1002a-b are small and light enough to be mounted onto a positioning arm 1008 and, therefore, can be used conveniently in scenarios in which the larger, more cumbersome, detector panels cannot be used. The detector panel 1002 can be placed, prior to the scan, in a fixed location. Alternatively, the detector panel 1002 can be moved by an operator during the scan via the positioning arm, allowing a field-of-view (FOV) of the scan to be optimized. Provisions can also be provided on the imaging system to store the detector panel and/or arm via a bracket or clip. In some embodiments, the detector panel 1002 is flat, planar, or mostly planar.

In some embodiments, a small configurable detector panel can be conveniently slipped into the small spaces behind hard-to-access objects to allow transmission images to be acquired, even though the field of view may be limited. As examples, embodiments may be used for x-ray scanning of targets such as transmission shafts or truck wheels, where there may not be enough space to move a detector attached to the scanner through the available space.

In some embodiments, the detector panel can be designed to be dual-mode—that is, it can be optimized to detect both transmitted x-rays for transmission imaging, to detect scattered x-rays to enhance the backscatter images, or to acquire side-scatter or forward-scatter images.

In some embodiments, configurable detector panel allows the imaging system to acquire transmission images by placing the detector panel behind the object being imaged relative to the imaging system. Alternatively, in some embodiments, the detector panel can be positioned on the same side of the target as the x-ray imaging system to enhance the backscatter image being acquired with the backscatter detectors built into the imaging system. A further use is to place the detector panel to the side of the object being imaging, allowing both side scatter and backscatter signal to contribute to a combined scatter image. Alternatively, the backscatter and side scatter images can be displayed independently to the operator. A further application is to use the detector panel to detect forward scatter, to enhance the detection of metallic items, such as guns and knives.

The configurable detector panel can have dimensions that are optimized to allow it to be placed in hard-to-reach locations behind or within an object being scanned, such as a car or truck. For example, in reference to FIG. 10, some embodiment detector panels can have a width 1006 of about 6″ and a length 1004 of 12″-18″, allowing them to be slipped in between a transmission housing and the vehicle chassis. A person of ordinary skill in the art can recognize that other dimensions, including other lengths 1004 and widths 1006, are possible. This is considerably smaller than the conventional, more cumbersome transmission detector panels currently available, which typically have dimensions of about 18″×24″. These larger conventional detector panels can be hard to position within the small spaces typically found during vehicle inspection and are too heavy to be mounted on a positioning arm.

In some embodiments, continuing to refer to FIG. 10, the detector panel can be mounted to a light weight positioning arm 1008, allowing the operator to position the detector prior to the scan, or to move it during the scan to enhance detection and field-of-view. The arm can be made from hollow aluminum or carbon fiber tubing, which combines rugged rigidity with light weight that is helpful for ease of use. The positioning arm 1008 can be telescoping, allowing it to have an adjustable length. Other embodiments incorporate a flexible positioning arm (not shown), allowing it to position the detector panel in confined spaces that would otherwise be inaccessible. Further embodiments can use hooks, clips, magnets, or other known means to attach the detector panel to a surface prior to performing the scan. Some embodiments can incorporate a counterweight with the positioning arm to alleviate any operator fatigue that may be possible.

The detector panel may have a width between 1 inch and 18 inches, for example, where width is illustrated in FIG. 10. As also illustrated in FIG. 10, the detector panel can have a length between 12 inches and 18 inches, in some non-limiting embodiments. In the case of a length of the detector panel that is curved, as illustrated in FIG. 11, for example, length may be measured and considered to be a circumference of a curved edge of the detector panel, such as a conference of a circularly arched detector panel or a non-circularly arched detector panel, at the top or bottom edge of the panel as illustrated in FIG. 11, for example.

The positioning arm may be removable from the external detector panel, either for convenience of transport, or for flexibility in imaging applications. The detector panel and/or the positioning arm can be stowed on a portion of the x-ray imaging system, such as on the movable x-ray scanning module or in a case in which the movable x-ray scanning module is stowed for transport.

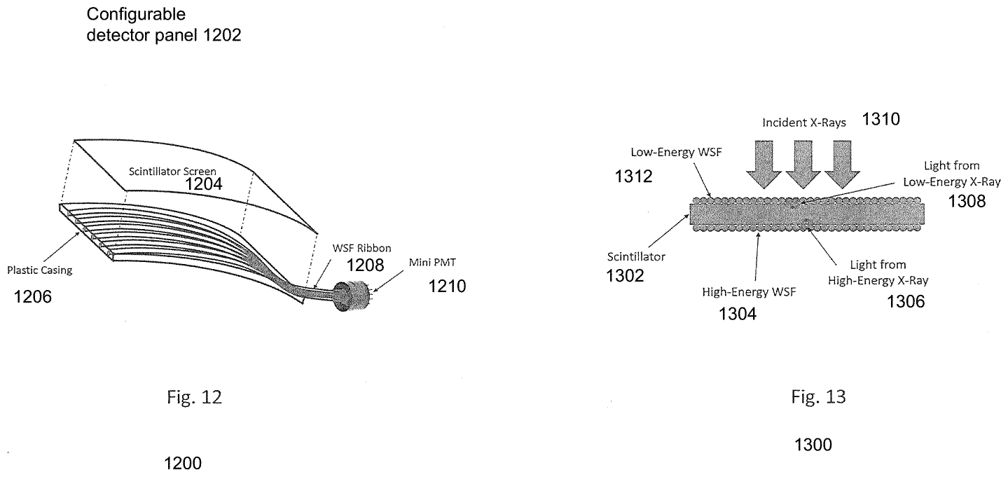

As described in connection with FIG. 12, certain detector panel materials can be flexible in order to allow for insertion of the detector panel into confined spaces. As illustrated in FIGS. 10-11, the positioning arm can be telescopic.

FIG. 11 is a diagram 1100 illustrating an example embodiment of the detector panel 1102 itself having flexibility, allowing it to be bent or have a configurable shape that allows it to be inserted into confined spaces. Still other embodiments can use a rigid detector panel that is non-planar and has a curved surface (e.g., concave or convex), which can allow the detector panel to be positioned more easily around rounded objects such as pipes, barrels, or fire extinguishers. In some embodiments, the housing material can be a flexible plastic, but a person of ordinary skill in the art can recognize that other flexible materials can be used. In some embodiments, the housing provides a light-proof cavity. In some embodiments, the light-proof cavity prevents all light from entering the cavity. In some embodiments, the light-proof cavity prevents a percentage of light from entering the cavity. In some embodiments, within the housing material is the scintillating phosphor, such that both the housing and the scintillating phosphor are flexible.

In some embodiments, the disclosed configurable detector panels can allow the same x-ray imaging system to be used in at least five possible imaging modes, with rapid interchangeability:
1. System used with built-in, compact backscatter detectors only. This mode allows backscatter images to be acquired in confined spaces and at close standoff distances.
2. System used with the configurable detector panel positioned to acquire transmission images in addition to the backscatter images.
3. System used with the configurable detector panel positioned to enhance backscatter images by placing the detector panel proximal to the x-ray imaging system. The backscatter signal from the detector panel is combined with the signal from the built-in backscatter detectors. This allows larger standoff distances or can enhance the imaging of organic items through thicker barriers such as steel.
4. System used with the configurable detector panel positioned to enhance backscatter images by placing the detector panel next to the object being imaged. The side-scatter signal from the detector panel can be combined with the signal from the built-in backscatter detectors. This allows larger standoff distances or can enhance the imaging of organic items through thicker barriers such as steel.
5. System used with the configurable detector panel positioned to acquire forward-scatter images by placing the detector panel not behind, but to the side, of the object being imaged. The forward-scatter signal from the detector panel can be useful for imaging metallic objects such as guns, in cases where the detector panel cannot be placed directly behind the object being imaged due to an obstruction (such as an engine block).

The detector panel may have a width between 1 inch and 18 inches, for example, where width is illustrated in FIG. 10. As also illustrated in FIG. 10, the detector panel can have a length between 12 inches and 18 inches, in some non-limiting embodiments. In the case of a length of the detector panel that is curved, as illustrated in FIG. 11, for example, length may be measured and considered to be a circumference of a curved edge of the detector panel, such as a conference of a circularly arched detector panel or a non-circularly arched detector panel, at the top or bottom edge of the panel as illustrated in FIG. 11, for example.

The positioning arm may be removable from the external detector panel, either for convenience of transport, or for flexibility in imaging applications. The detector panel and/or the positioning arm can be stowed on a portion of the x-ray imaging system, such as on the movable x-ray scanning module or in a case in which the movable x-ray scanning module is stowed for transport.

As described in connection with FIG. 12, certain detector panel materials can be flexible in order to allow for insertion of the detector panel into confined spaces. As illustrated in FIGS. 10-11, the positioning arm can be telescopic.

FIG. 12 is a diagram 1200 illustrating an example embodiment of the configurable detector panel 1202. The configurable detector panel 1202 includes one or more phosphor scintillation screens 1204 approximately 6″ wide by 12″ long that efficiently absorb the incident x-rays and convert the x-ray energy into scintillation light. A person of ordinary skill in the art can recognize that other scintillation screens 1204 can be employed. A typical thickness of scintillator screen 1204 for a 140 kV instrument can be approximately 80 mg/cm² BaFCl on the front source-facing screen with 250 mg/cm² or 350 mg/cm² BaFCl on the rear-facing screen. Alternatively, a single sheet of 500 mg/cm² BaFCl can be used. The scintillation light is collected via one or more layers of Wavelength-Shifting Fibers (WSF) connected to a WSF ribbon 1208 that are optically coupled to the one or more scintillation screens 1204. The fibers are bundled together and optically coupled to a photodetector, which can, for example, be one or more 1″ diameter Photomultiplier Tubes (PMTs) 1210 or some other photodetector. Alternatively, wavelength-shifting sheets (not shown) can be used. The entire detector assembly is encased in a thin light-proof housing, such as plastic casing 1206, that also provides environmental protection for the components. In an embodiment, the detector panel can be attached to a removable lightweight positioning arm, which can be optionally telescoping, foldable, or bendable into different spatial configurations.

In an embodiment, the detector panel can include a low-profile light cavity lined with scintillating phosphor screen. The optical readout of the scintillator is achieved with one or more photodetectors, such as PMTs. As an example, the scintillator screen can include a BaFCl screen, read out with four 1″ diameter PMTs, positioned toward the four corners of the assembly. Typical thicknesses of scintillator screen for a 140 kV instrument range from 80 mg/cm² BaFCl on the front source-facing interior surface of the detector assembly cavity, to 250 mg/cm² BaFCl on the sides and rear interior surfaces.

In another embodiment, the detector panel itself can be flexible, by using scintillating phosphor that has a flexible substrate. Alternatively, the scintillating phosphor can be mixed into a flexible, optically transparent matrix material, for example. Since the WSF layers are flexible, the entire detector panel can then be designed to be flexible with the right choice of light-proofing and outer housing material. In some embodiments, the housing material can be a flexible plastic, but a person of ordinary skill in the art can recognize that other flexible materials can be used. In some embodiments, the housing provides a light-proof cavity. In some embodiments, the light-proof cavity prevents all light from entering the cavity. In some embodiments, the light-proof cavity prevents a percentage of light from entering the cavity. In some embodiments, within the housing material is the scintillating phosphor, such that both the housing and the scintillating phosphor are flexible.

A further embodiment provides dual-energy capability for the detector panel. This can use an approach described in U.S. Pat. No. 9,285,488 to Arodzero et al., in which two sheets of scintillator are each read out separately by two respective layers of WSF, and the ratio of the magnitude of the two signals is used to characterize the energy spectrum of the incident beam at any given instant. The above referenced patent is hereby incorporated by reference in its entirety.

Alternatively, the approach described in PCT Pat. App. Pub. No. WO 2022/040609, entitled “X-Ray Detection Structure and System” can be used, in which only one sheet of scintillating phosphor is used, but the signals from two separate layers of WSF on the entrance and exit side of the sheet are used to characterize the energy spectrum of the incident beam.

FIG. 13 illustrates an example embodiment of one sheet of scintillating phosphor or scintillator 1302 in which the signals from two layers of WSF characterize the energy spectrum of the incident x-ray beam(s) 1310. The layers of WSF can include a low-energy WSF 1312 and high-energy WSF 1304. The incident rays enter the low-energy WSF 1312 and exit the high-energy WSF 1304, where the light from the high-energy x-ray 1306 exits.

Analog signals from the one or more PMTs are summed together and then sent to the imaging instrument via a coaxial cable and connector. Alternatively, the signals can be digitized via circuitry installed within the detector panel, and the digitized signals can then be wirelessly transmitted to the imaging instrument, or wirelessly sent to some other remote display device, such as a tablet or a laptop computer. In further embodiments, the output signals can be transmitted both wirelessly and via electrical cables.

When used to detect scatter, the output signals from the detector panel can be combined electrically or in software with the output signals from the built-in backscatter detectors in the instrument before being displayed. Alternatively, the signals can be processed and/or displayed separately. This can be helpful, for example, when looking at objects positioned at a larger distance behind a thick, highly scattering barrier. Scatter from the concealing barrier will preferentially be detected in the built-in backscatter detectors because the active areas of those detectors are closer to the scatter point where the primary beam is incident on the barrier. Depending on where it is positioned, the detector panel may be less sensitive to scatter from the barrier as its active area is farther away from the scatter point on the barrier, and therefore the signal to noise ratio of the concealed object in the backscatter image can be significantly improved if the signal from the detector panel is displayed separately.

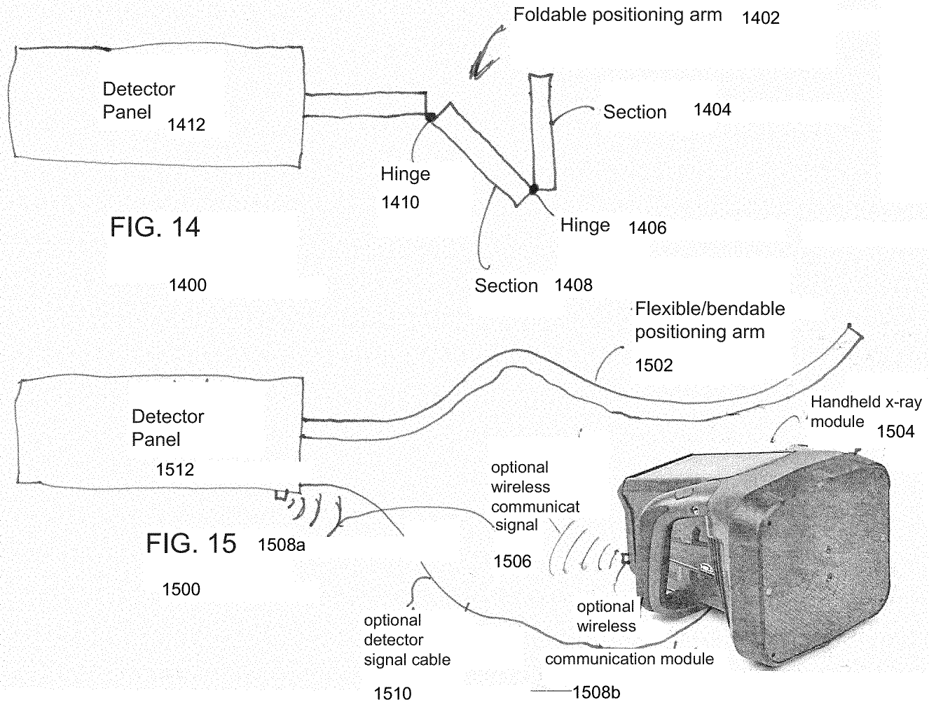

FIG. 14 is a schematic diagram illustrating an embodiment detector panel system having a foldable positioning arm with various hinged sections. FIG. 14 is a diagram 1400 illustrating an example embodiment of a foldable positioning arm 1402 can be varied in length by other means, such as by having a full foldable positioning arm design. Such a design includes section 1404 and section 1408 joined by a hinge 1406. In an embodiment, a hinge 1410 connects the foldable positioning arm 1402 to the detector panel 1412.

FIG. 15 is a schematic diagram illustrating an embodiment detector panel system having a bendable positioning arm optional wired or wireless detector signal communications with the handheld imager of FIG. 2. FIG. 15 is a diagram 1500 illustrating an example embodiment of a positioning arm 1502 that can be flexible, such as by bending. In this manner, a bendable or otherwise flexible positioning arm 1502 can also have a variable length. In some embodiments, the positioning arm 1502 can be configured to incorporate a counterweight to alleviate operator fatigue. In reference to this description, it will be understood that a detector panel 1512 that is cantilevered at an end of the positioning arm can produce operator fatigue in an operator that holds an opposite end of the positioning. A counterweight can thereby be placed at a strategic position connected to the positioning arm to alleviate this fatigue.

The detector panel 1512 can be stationary during a scan, or can be moved by an operator during a scan. The detector panel 1512 can be configured to be connected to the imaging system via an electrical or other optional detector signal cable 1510, as illustrated in FIG. 15, for example. However, FIG. 15 also illustrates an optional wireless communication module 1508 that is positioned on the detector panel 1508a and on the handheld x-ray scanning module 1508b, correspondingly, to communicate with each other via an optional wireless communication signal 1506, thus providing a wireless link. It should be understood that, where a detector panel in an embodiment is connected to an x-ray scanning module via a detector signal cable, the signal cable should be flexible, thus allowing the detector panel to be positioned, via the positioning arm, independently, with respect to the x-ray scanning module. A person of ordinary skill of the art can recognize that the optional detector signal cable 1510 or optional wireless communication modules 1508a-b and optional wireless communication signal 1506 can be employed in any other embodiment described herein, and is not limited to the embodiment shown in FIG. 15 having a flexible/bendable positioning arm 1502.

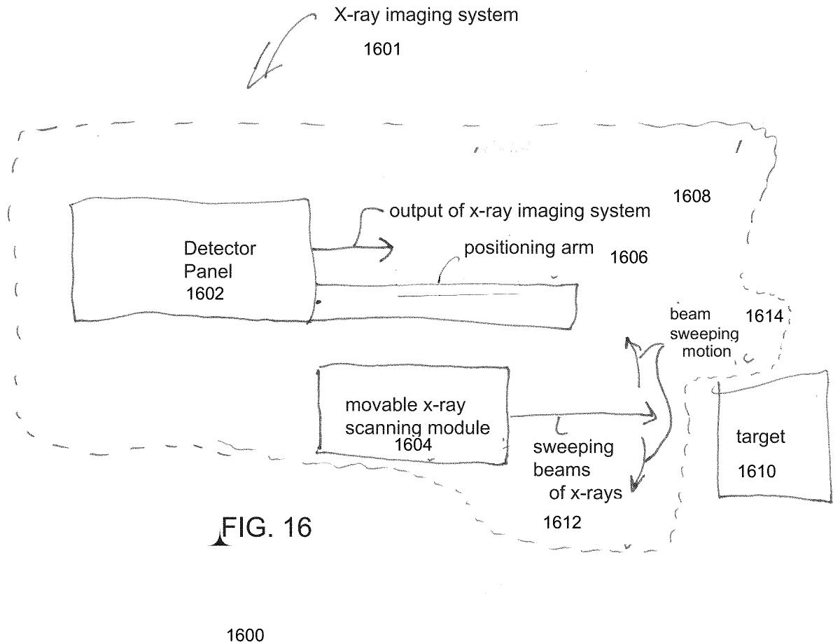

FIG. 16 illustrates, in a generalized manner, a scope of various embodiment x-ray imaging systems. FIG. 16 illustrates an x-ray imaging system that includes a movable x-ray scanning module that is configured to output generate an output a sweeping beam of x-rays toward a target. The system also includes an external detector panel and a positioning arm, wherein the external detector panel is configured to be mounted onto the positioning arm to allow an operator to position the detector relative to the movable x-ray scanning module. In particular, the detector panel may thereby, with use of the positioning arm, be movable, independent from the movable x-ray scanning module, in order to position the detector panel optimally for an x-ray scan of the target. The external detector module is configured to output an x-ray image signal responsive to x-rays from a target resulting from the sweeping beam of x-rays being incident at the target, such that an x-ray image of the target can be formed using the x-ray signal.

As further described hereinabove, the x-rays received at the external detector module may be x-rays that are transmitted through the target may be x-rays from the sweeping beam that are transmitted through the target. In this manner, an x-ray image formed from the x-ray imaging signal may be a transmission x-ray image. On the other hand, the detector panel, with the aid of the positioning arm, may be placed in a position to receive x-rays that are scattered from the target, such as by forward scattering, back scattering, or side scattering as a result of x-rays from the sweeping beam being incident at the target. Correspondingly, images formed from such x-ray imaging signals may be forward scatter, backscatter, or side scatter images, for example.

FIG. 16 is a diagram 1600 illustrating an example embodiment of an x-ray imaging system 1601. As described hereinabove, the detector panel 1602 can be configured to be positioned to acquire transmission images, backscatter images, or side scatter images of an inspected object or target 1610. This can depend upon where the detector panel 1602 is placed with the positioning arm 1606, relative to the movable x-ray scanning module 1604, the sweeping beam of x-rays 1612 (e.g., having a beam sweeping motion 1614) and the target 1610, as will be readily understood by those of skill in the art of x-ray imaging. The x-ray imaging system 1601 can output images 1608 such as forward scatter images.

Furthermore, the detector panel 1602 can be part of an x-ray detector/imaging system 1601 for detecting a scanning beam of x-rays 1612, where the detector system 1601 includes one or more scintillator volumes configured to be oriented along a scanner axis of a scanning beam of x-rays to receive x-rays from the scanning beam transmitted through a target, the one or more scintillator volumes further configured to produce scintillation photons responsive to receiving the x-rays. A plurality of ribbons of wavelength shifting fibers (WSFs) optically coupled to the one or more scintillator volumes along the scanner axis via a spatial periodic adjacency of the plurality of ribbons to the scan axis can also be provided. The plurality of ribbons can be configured to receive scintillation photons from the one or more scintillator volumes via the spatial periodic adjacency as the scanning beam of x-rays scans over the scan axis. Such a detector system 1601, incorporating the detector panel 1602, can include at least one respective photodetector coupled to an end of each respective ribbon of the plurality of ribbons, each respective photodetector configured to detect the scintillation photons carried by the respective ribbon and to produce a respective signal responsively. The detector system 1601 can also include a signal combiner that combines, selectively, respective signals from one or more ribbons of the plurality of ribbons, for positions of the scanning beam along the scanner axis, to create a combined signal representing a scan of the target with enhanced spatial resolution.

The system of FIG. 16 can have the detector panel 1602 part of a light detection structure including a tubular support structure having a curved outer surface; and a plurality of ribbons of wavelength-shifting fibers (WSFs) wrapped around the curved outer surface in a spatially periodic, substantially helical pattern, wherein the plurality of ribbons of WSFs are configured to carry light to be detected at respective ends of respective ribbons of the plurality of ribbons.

In another variation, the system of FIG. 16 can have the detector panel being part of a detector system for determining a characteristic of an energy spectrum of x-rays, the detector system including a scintillator volume having an entrance surface and an exit surface, the entrance surface configured to receive incident x-rays, the scintillator volume configured to emit scintillation light responsive to the incident x-rays, and the exit surface configured to pass a portion of the incident x-rays that traverse a thickness of the scintillator volume between the entrance surface and the exit surface; a first plurality of light guides optically coupled to the entrance surface of the scintillator volume; a second plurality of light guides optically coupled to the exit surface of the scintillator volume; at least one first photodetector optically coupled to an end of the first plurality of light guides and configured to output a first signal responsive to scintillation light from the scintillator volume; at least one second photodetector optically coupled to an end of the second plurality of light guides and configured to output a second signal responsive to scintillation light from the scintillator volume; and a spectrum analyzer configured to receive the first and second signals responsive to the scintillation light from the scintillator volume and to determine a characteristic of an energy spectrum of the incident x-rays based on the first and second signals.

In another variation of FIG. 16, the detector panel can be part of a detector structure optimized for use with a scanning beam of X-rays, the structure including: a plurality of ribbons of wavelength-shifting fibers (WSF) optically coupled to one or more layers of scintillator volumes, wherein the scintillator volumes are arranged to optically couple to the WSF ribbons in a repeating pattern along one or more axes of the detector; at least one photodetector coupled to one or more ends of each of the ribbons for detecting scintillation photons; means for combining the signals from one or more of the ribbons for each orientation of the scanning beam to create a combined signal for each beam orientation; a processor for creating an image from the combined signals.

In another variation of FIG. 16, the detector panel can be part of a light detection structure including: a plurality of scintillator volumes configured to be oriented spaced from each other and in a spatially periodic form along a scan axis of a scanning beam of x-rays to receive x-rays from the scanning beam transmitted through a target, the plurality of scintillator volumes further configured to produce scintillation photons responsive to receiving the x-rays; and a wavelength-shifting fiber (WSF) ribbon optically coupled to the plurality of scintillator volumes along the scan axis, the ribbons configured to receive scintillation photons from the plurality of scintillator volumes via the optical coupling as the scanning beam of x-rays scans over the scan axis.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. An x-ray imaging system, comprising:
a movable x-ray scanning module configured to generate a sweeping beam of x-rays;
a positioning arm;
a detector panel coupled to or configured to be coupled to the positioning arm, the positioning arm configured to allow an operator to position the detector panel relative to the movable x-ray scanning module and with an orientation for receiving x-rays from a target resulting from the sweeping beam of x-rays being incident at the target or transmitted through the target.

2. The x-ray imaging system of claim 1, wherein the detector panel is an auxiliary detector panel, and wherein the movable x-ray scanning module includes a primary detector oriented to receive backscatter x-rays from the target resulting from the sweeping beam of x-rays being incident at the target.

3. The x-ray imaging system of claim 2, wherein the primary detector is operably coupled to a primary detector module that is configured to output a primary x-ray image signal, the primary x-ray image signal enabling a processor to form a primary x-ray image; and wherein the auxiliary detector panel is operably coupled to an auxiliary detector module that is configured to output an auxiliary x-ray image signal responsive to the auxiliary detector panel's receiving x-rays from a target resulting from the sweeping beam of x-rays being incident at the target or transmitted through the target.

4. The x-ray imaging system of claim 3, further comprising a processor operably coupled to at least one of the primary detector module and the auxiliary detector module, wherein the processor is configured to form an x-ray image as a function of the primary x-ray image signal, auxiliary x-ray image signal, or combination thereof.

5. The x-ray imaging system of claim 1, wherein the positioning arm has a mechanical relationship with the moveable x-ray scanning module selected from a group comprising: coupled to the movable x-ray scanning module; detachable from the x-ray scanning module; and independent from the x-ray scanning module.

6. The x-ray imaging system of claim 1, wherein the detector panel is at least one of (i) non-planar and (ii) flexible.

7. The x-ray imaging system of claim 1, further comprising at least one location or orientation sensor located in at least one of the positioning arm, detector panel, and movable x-ray scanning module, the at least one location or orientation sensor configured to output a signal that can be used by a processor to determine a relative location or orientation of the detector panel with respect to the movable x-ray scanning module.

8. The x-ray imaging system of claim 1, wherein the positioning arm further includes a plurality of telescoping sections, the plurality of telescoping sections sufficiently stiff in a fully extended state to support the detector panel in an operator-defined position and orientation.

9. The x-ray imaging system of claim 1, wherein the positioning arm is adjustable along its length.

10. The x-ray imaging system of claim 1, wherein the detector panel in coupled arrangement with the positioning arm is configured to be positioned by the operator to receive at least one of (i) transmission x-rays through the target and (ii) backscatter, side scatter, or forward scatter x-rays from the target.

11. The x-ray imaging system of claim 1, further comprising: (i) at least one of an electrical cable configured to connect the detector panel operably to a processor of the x-ray imaging system or (ii) a wireless link subsystem configured to connect the detector panel operably to the processor of the x-ray imaging system via a wireless communications protocol.

12. The x-ray imaging system of claim 1, wherein the detector panel comprises:
one or more scintillator volumes configured to be oriented along a scan axis of a scanning beam of x-rays to receive x-rays from the scanning beam transmitted through a target, the one or more scintillator volumes further configured to produce scintillation photons responsive to receiving the x-rays;
a plurality of ribbons of wavelength-shifting fibers (WSFs) optically coupled to the one or more scintillator volumes along the scan axis via a spatial periodic adjacency of the plurality of ribbons to the scan axis, the plurality of ribbons configured to receive scintillation photons from the one or more scintillator volumes via the spatial periodic adjacency as the scanning beam of x-rays scans over the scan axis;
at least one respective photodetector coupled to an end of each respective ribbon of the plurality of ribbons, each respective photodetector configured to detect the scintillation photons carried by the respective ribbon and to produce a respective signal responsively; and
a signal combiner configured to combine, selectively, respective signals from one or more ribbons of the plurality of ribbons, for positions of the scanning beam along the scan axis, to create a combined signal representing a scan of the target with enhanced spatial resolution.

13. The x-ray imaging system of claim 1, wherein the detector module comprises:
a light detection structure, the light detection structure including a tubular support structure having a curved outer surface, and a plurality of ribbons of wavelength-shifting fibers (WSFs) wrapped around the curved outer surface in a spatially periodic, substantially helical pattern, the plurality of ribbons of WSFs being configured to carry light to be detected at respective ends of respective ribbons of the plurality of ribbons.

14. The x-ray imaging system of claim 1, wherein the detector module comprises:
a scintillator volume having an entrance surface and an exit surface, the entrance surface configured to receive incident x-rays, the scintillator volume configured to emit scintillation light responsive to the incident x-rays, and the exit surface configured to pass a portion of the incident x-rays that traverse a thickness of the scintillator volume between the entrance surface and the exit surface;
a first plurality of light guides optically coupled to the entrance surface of the scintillator volume;
a second plurality of light guides optically coupled to the exit surface of the scintillator volume;
at least one first photodetector optically coupled to an end of the first plurality of light guides and configured to output a first signal responsive to scintillation light from the scintillator volume;
at least one second photodetector optically coupled to an end of the second plurality of light guides and configured to output a second signal responsive to scintillation light from the scintillator volume; and
a spectrum analyzer configured to receive the first and second signals responsive to the scintillation light from the scintillator volume and to determine a characteristic of an energy spectrum of the incident x-rays based on the first and second signals.

15. The x-ray imaging system of claim 1, further comprising:
a detector structure configured for use with the scanning beam of x-rays, the detector panel, and a detector module that is configured to output an x-ray image signal responsive to the detector panel's receiving x-rays from a target resulting from the sweeping beam of x-rays being incident at the target, the detector structure comprising:
a plurality of ribbons of wavelength-shifting fibers (WSF) optically coupled to one or more layers of scintillator volumes, wherein the scintillator volumes are arranged to optically couple to the WSF ribbons in a repeating pattern along one or more axes of the detector;
at least one photodetector coupled to one or more ends of each of the ribbons for detecting scintillation photons;
a combiner configured to combine the signals from one or more of the ribbons for each orientation of the scanning beam to create a combined signal for each beam orientation; and
a processor configured to create an image from the combined signal.

16. The x-ray imaging system of claim 1, further comprising:
a light detection structure, the light detection structure including a plurality of scintillator volumes configured to be oriented spaced from each other and in a spatially periodic form along a scan axis of a scanning beam of x-rays to receive x-rays from the scanning beam transmitted through a target, the plurality of scintillator volumes further configured to produce scintillation photons responsive to receiving the x-rays; and
a wavelength-shifting fiber (WSF) ribbon optically coupled to the plurality of scintillator volumes along the scan axis, the ribbons configured to receive scintillation photons from the plurality of scintillator volumes via the optical coupling as the scanning beam of x-rays scans over the scan axis.

17. A detector panel comprising:
a housing made of a flexible material, the housing defining a light-capturing cavity and preventing ambient light from entering the light-capturing cavity;
at least one scintillation screen residing within the light-capturing cavity of the housing, the combination of the housing and the at least one scintillation screen being flexible.

18. The detector panel of claim 17, wherein the housing includes or defines a coupling member that enables the detector panel to be coupled to a positioning arm or to a complementary coupling member of the positioning arm or other structure.

19. The detector panel of claim 18, wherein the positioning arm is at least one of telescoping, flexible, and foldable.

20. The detector panel of claim 17, wherein the housing has a port for outputting a signal, the detector panel further comprising:
a detector module configured to output an x-ray image signal responsive to receiving x-rays at the at least one scintillation screen from a target resulting from the sweeping beam of x-rays being incident at a target, such that an x-ray image of the target can be formed using the x-ray image signal.

21. The detector panel of claim 17, further comprising:
at least one location or orientation sensor located in the housing configured to determine a location or orientation of the detector panel relative to a source of a sweeping beam of x-rays.
